(19) United States
(12) Patent Application Publication
(10) Pub. No.: US 2025/0137662 A1
(43) Pub. Date: May 1, 2025

(54) HEATING COOKER

(71) Applicant: SHARP KABUSHIKI KAISHA, Osaka (JP)

(72) Inventor: SHINJI ASAMI, Osaka (JP)

(21) Appl. No.: 18/926,881

(22) Filed: Oct. 25, 2024

(30) Foreign Application Priority Data
Oct. 31, 2023 (JP) 2023-186342

(51) Int. Cl. F24C 15/32; F24C 15/00; F24C 15/22

(52) U.S. Cl. CPC F24C 15/325; F24C 15/006; F24C 15/22

(57) ABSTRACT

A heating cooker includes a heating cooking compartment, a housing, a first heater unit, a cooling fan, and a second flow channel section. The heating cooking compartment allows a heating-target object to be accommodated therein. The housing accommodates the heating cooking compartment. The first heater unit heats the heating-target object. The cooling fan generates a first air flow circulating through a space other than the first heater unit and a second air flow circulating through the first heater unit. The second flow channel section guides only the second air flow that has passed through the first heater unit to the vicinity of a discharge unit communicating with the outside of the housing. The second air flow guided to the vicinity of the discharge unit through the second flow channel section and the first air flow are joined and discharged from the discharge unit.

### BACKGROUND OF THE INVENTION

### 1. Technical Field

The present disclosure relates to a heating cooker.

### 2. Description of the Related Art

JP 2005-3317 A discloses a heating cooker. The heating cooker disclosed in JP 2005-3317 A includes an air blowing part that suctions outside air to generate cooling air, an upper heat storage chamber that collects heat flows above a heating compartment, and a mixing part that is disposed upstream of an exhaust port and supplies the cooling air to the heat flows in the upper heat storage chamber.

### SUMMARY OF THE INVENTION

However, in the heating cooker disclosed in JP 2005-3317 A, the cooling air parallel to a traveling direction of the heat flow is supplied from an outer circumferential part of the heat flow. Therefore, the heat flow and the cooling air are not sufficiently mixed, and there is room for improvement in reduction of a temperature of the discharged air flow.

In view of the above problem, an object of the present disclosure is to provide a heating cooker capable of reducing a temperature of a discharged air flow.

According to one aspect of the present disclosure, a heating cooker includes a heating cooking compartment, a housing, a heating unit, a fan, and a flow channel. The heating cooking compartment accommodates a heating-target object. The housing accommodates the heating cooking compartment. The heating unit heats the heating-target object. The fan generates a first air flow circulating through a space other than the heating unit and a second air flow circulating through the heating unit. The flow channel is configured to guide only the second air flow that has passed through the heating unit to the vicinity of a discharge unit communicating with an outside of the housing. The second air flow guided to the vicinity of the discharge unit through the flow channel and the first air flow are joined and are discharged from the discharge unit.

According to the heating cooker of the present disclosure, a temperature of the discharged air flow can be reduced.

### BRIEF DESCRIPTION OF THE DRAWINGS

FIG. 1 is a perspective view illustrating a heating cooker according to an embodiment of the present disclosure;

FIG. 2 is a perspective view illustrating the heating cooker in a state where a housing is removed according to the embodiment;

FIG. 3 is a perspective view illustrating the heating cooker in a state where the housing is removed according to the embodiment;

FIG. 4 is a perspective view illustrating a door according to the embodiment;

FIG. 5 is a view illustrating a schematic cross section of the heating cooker according to the embodiment;

FIG. 6 is a view illustrating a schematic cross section of an air blower according to the embodiment;

FIG. 7 is a perspective view illustrating the heating cooker in a state where the housing is removed according to the embodiment;

FIG. 8 is a perspective view illustrating the heating cooker in a state where the housing is removed according to the embodiment;

FIG. 9 is a bottom view illustrating the heating cooker in a state where the housing is removed according to the embodiment;

FIG. 10 is a cross-sectional view along line X-X in FIG. 9;

FIG. 11 is a view illustrating a flow of an air flow; and

FIG. 12 is a block diagram illustrating a configuration of the heating cooker according to the embodiment.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and descriptions thereof will not be repeated.

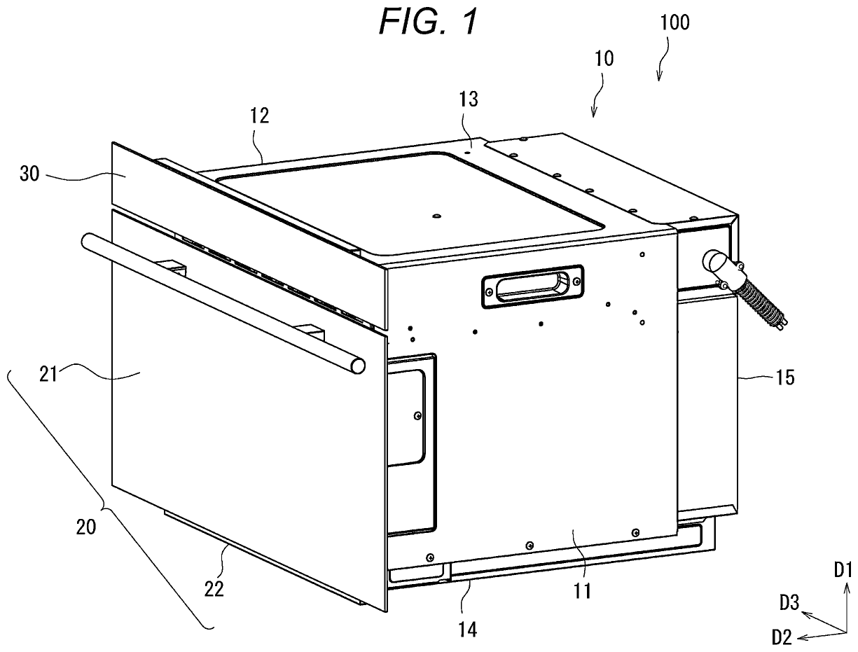

With reference to FIG. 1, a heating cooker 100 according to the embodiment will be described. FIG. 1 is a perspective view illustrating the heating cooker 100. In addition, FIG. 1 illustrates the external appearance of the heating cooker 100 when viewed diagonally from the upper right front. As illustrated in FIG. 1, the heating cooker 100 heats and cooks a heating-target object. The heating-target object is, for example, a food item. The heating cooker 100 includes a housing 10, a door 20, and an operation panel 30.

The operation panel 30 is a substantially rectangular plate-shaped member. The operation panel 30 receives an operation from a user. The operation includes, for example, a cooking method for heating and cooking a heating-target object. Specifically, the operation panel 30 includes a display unit. The display unit displays various items of information. Specifically, the display unit includes a liquid crystal panel.

In the embodiment, a side of the heating cooker 100 on which the operation panel 30 is disposed is defined as a front side of the heating cooker 100, and a side (back surface side) opposite to the front side is defined as a rear side of the heating cooker 100. In addition, when the heating cooker 100 is viewed from the front side, a right side is defined as a right side of the heating cooker 100, and a side opposite to the right side is defined as a left side of the heating cooker 100. In addition, in a direction orthogonal to a front-rear direction and a left-right direction of the heating cooker 100, a side on which the operation panel 30 is disposed is defined as an upper side of the heating cooker 100, and a side (bottom side) opposite to the upper side is defined as a lower side of the heating cooker 100. Note that, these directions and sides are not intended to limit directions and sides when the heating cooker 100 of the present disclosure is used. In the embodiment, a first direction D1 is an upward direction. A second direction D2 is a forward direction. A third direction D3 is a left direction.

The housing 10 is a box-shaped member. Specifically, the housing 10 has a right outer wall 11, a left outer wall 12, an upper outer wall 13, a lower outer wall 14, and a rear outer wall 15. The rear outer wall 15 intersects the second direction D2. The right outer wall 11 and the left outer wall 12 face each other in the third direction D3. The upper outer wall 13 and the lower outer wall 14 face each other in the first direction D1. The housing 10 accommodates the heating cooking compartment 50 to be described below.

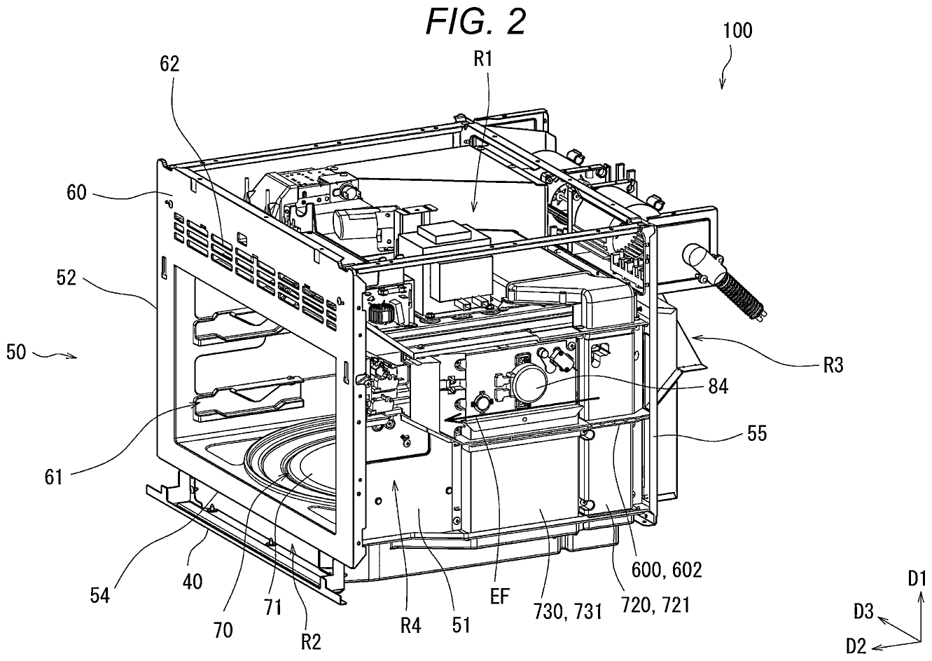

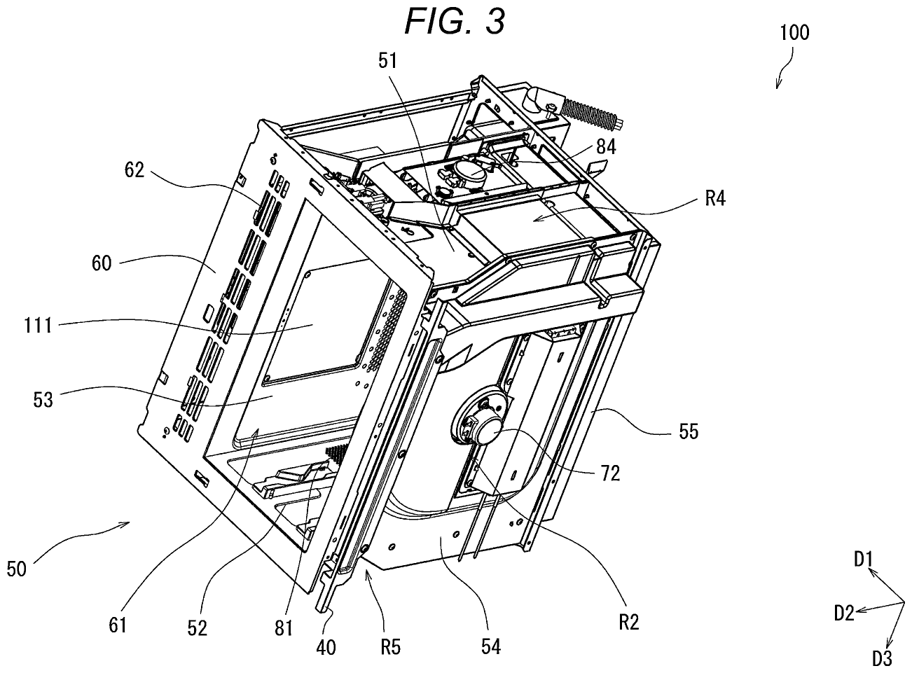

Continuing, a heating cooking compartment 50 will be described with reference to FIGS. 1 to 3. FIGS. 2 and 3 are perspective views illustrating the heating cooker 100 from which the housing 10 has been removed. FIG. 2 illustrates the external appearance of the heating cooker 100 when viewed diagonally from the upper right front. FIG. 3 illustrates the external appearance of the heating cooker 100 when viewed diagonally from the lower right front. As illustrated in FIGS. 2 and 3, the heating cooker 100 further includes the heating cooking compartment 50, a front wall 60, and a placement portion 70.

The heating cooking compartment 50 allows a heating-target object to be accommodated therein. The heating cooking compartment 50 is accommodated in the housing 10. The heating cooking compartment 50 allows a heating-target object to be accommodated therein. The heating cooking compartment 50 has, for example, a substantially rectangular parallelepiped shape. Specifically, the heating cooking compartment 50 has a right wall 51, a left wall 52, an upper wall 53, a lower wall 54, and a rear wall 55. The rear wall 55 intersects the second direction D2. The right wall 51 and the left wall 52 face each other in the third direction D3. The upper wall 53 and the lower wall 54 face each other in the first direction D1. A material of each of the right wall 51, the left wall 52, the upper wall 53, the lower wall 54, and the rear wall 55 is, for example, stainless steel. Note that the material of each wall is not limited to stainless steel. Any metal having at least predetermined heat resistance and reflectance characteristics may be used.

The placement portion 70 is a dish-shaped member. The placement portion 70 is accommodated in the heating cooking compartment 50. The placement portion 70 is configured to allow the heating-target object to be placed. As illustrated in FIGS. 2 and 3, the placement portion 70 includes a table 71 and a drive motor 72.

The heating-target object is placed on the table 71. The table 71 is disposed at the center of the lower wall 54.

The drive motor 72 rotates the table 71. To be specific, the drive motor 72 rotates the table 71 about a rotation axis in the first direction DI. The drive motor 72 is disposed below the heating cooking compartment 50. That is, during operation of the heating cooker 100, the drive motor 72 generates heat.

The heating cooker 100 further includes a first space R1, a second space R2, a third space R3, a fourth space R4, and a fifth space R5. The first space R1 is disposed between the upper outer wall 13 and the upper wall 53. The second space R2 is disposed between the lower outer wall 14 and the lower wall 54. The third space R3 is disposed between the rear outer wall 15 and the rear wall 55. The fourth space R4 is disposed between the right outer wall 11 and the right wall 51. The fifth space R5 is disposed between the left outer wall 12 and the left wall 52.

The front wall 60 is a plate-shaped member having a quadrangular shape. The front wall 60 faces the rear wall 55. In addition, the front wall 60 faces the rear outer wall 15. The front wall 60 has an opening 61 and suction ports 62. The opening 61 allows an inside and an outside of the heating cooking compartment 50 to communicate with each other. In other words, the heating cooking compartment 50 has the opening 61 through which the heating-target object passes.

A plurality of suction ports 62 are disposed above the opening 61. Each of the plurality of suction ports 62 allows an inside and an outside of the first space RI to communicate with each other. The plurality of suction ports 62 form eight columns. In each of the eight columns of the suction ports 62, three suction ports 62 are arranged in a column in an up-down direction.

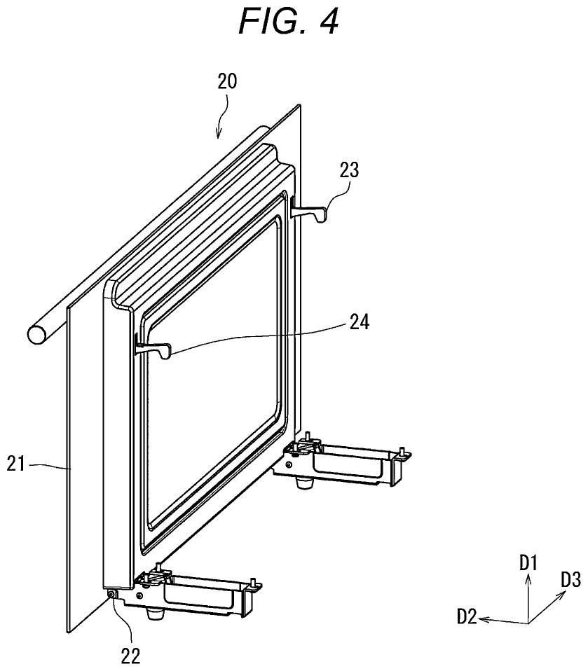

Continuing, the door 20 will be described with reference to FIGS. 1 to 4. FIG. 4 is a perspective view illustrating the door 20. The door 20 opens and closes the opening 61. As illustrated in FIGS. 1 to 4, the door 20 includes a substantially rectangular plate-shaped member 21 and a rotary shaft unit 22.

The rotary shaft unit 22 is positioned below the plate-shaped member 21. The plate-shaped member 21 opens and closes the opening 61. Specifically, the plate-shaped member 21 rotates about a rotation axis in the third direction D3. The plate-shaped member 21 opens the opening 61 in a state of being orthogonal to the first direction D1. On the other hand, the plate-shaped member 21 closes the opening 61 in a state of being orthogonal to the second direction D2.

To be specific, the door 20 includes a first connection member 23 and a second connection member 24. Both the first connection member 23 and the second connection member 24 connect the heating cooking compartment 50 and the door 20 when the door 20 is positioned at a closed position.

The first connection member 23 and the second connection member 24 are attached to the plate-shaped member 21. The first connection member 23 and the second connection member 24 face each other in the left-right direction. The first connection member 23 is attached to a left edge portion of a rear surface of the plate-shaped member 21. The second connection member 24 is attached to a right edge portion of the rear surface of the plate-shaped member 21.

For example, each of the first connection member 23 and the second connection member 24 has a hook member. The hook member is a plate-shaped member having a longitudinal direction thereof in the front-rear direction. The hook member includes a claw portion and a rotation pin portion. The rotation pin portion is positioned at one end portion of the hook member. The rotation pin portion rotates about a rotation axis extending in the third direction D3. On the other hand, the claw portion has a projecting portion projecting downward. The claw portion is positioned at the other end portion of the hook member. As a result, the claw portion is rotatable around the rotation pin portion. The claw portion can engage with a hole formed in the front wall 60.

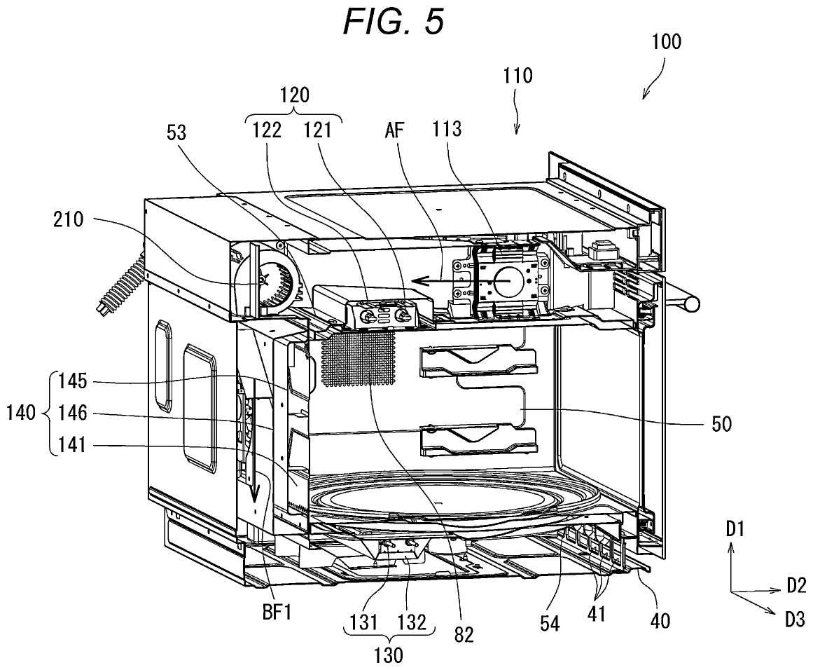

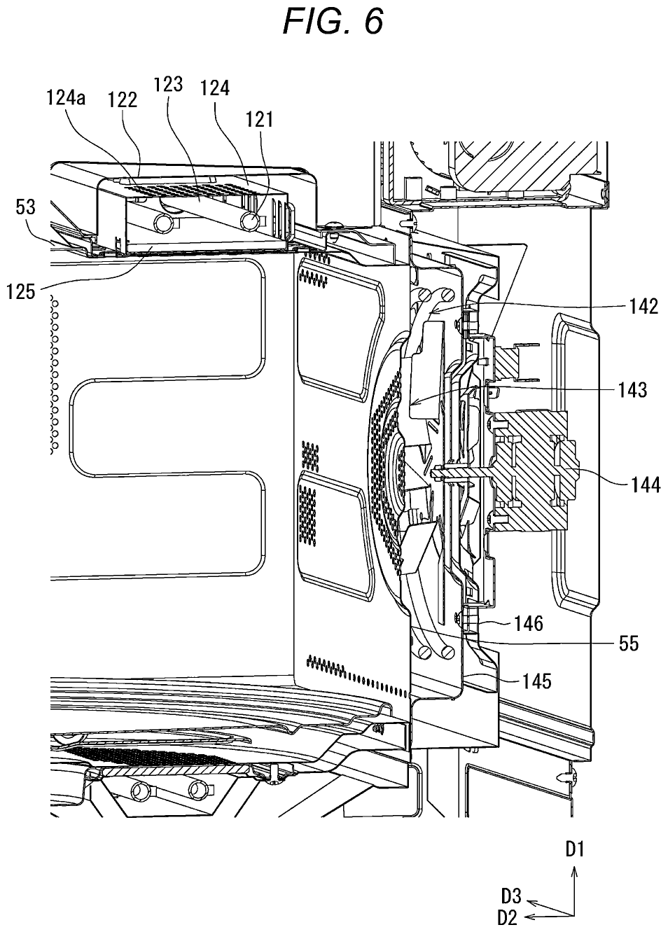

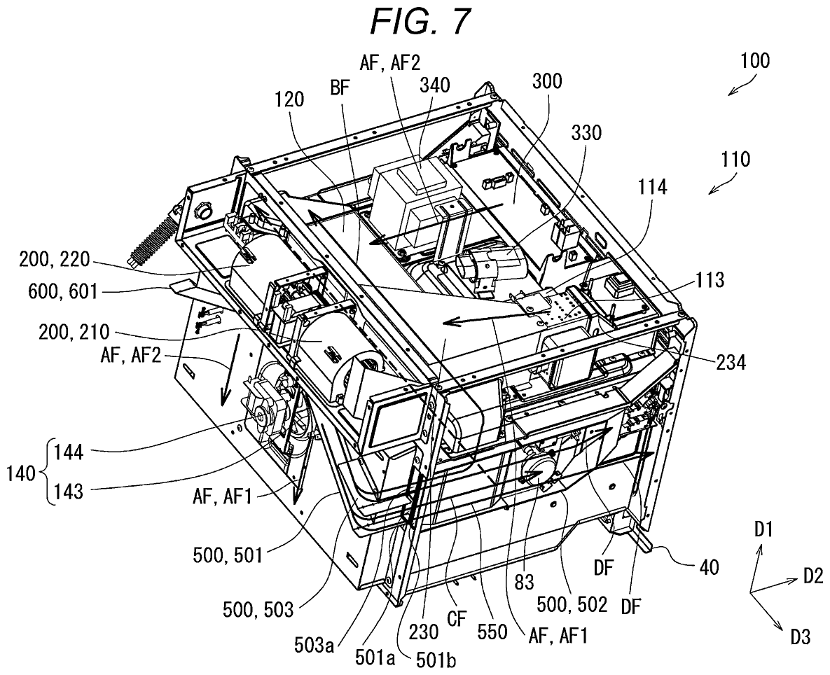

Next, the heating cooker 100 will be further described with reference to FIGS. 5 to 7. FIG. 5 is a view illustrating a schematic cross section of the heating cooker 100. To be specific, FIG. 5 is a cross-sectional view illustrating the heating cooker 100 cut along a plane orthogonal to the third direction D3. In addition, FIG. 6 is a view illustrating a schematic cross section of an air blower 140 according to the embodiment. Further, FIG. 7 is a perspective view illustrating the heating cooker 100 in a state where the housing 10 is removed. To be specific, FIG. 7 illustrates the external appearance of the heating cooker 100 when viewed diagonally from the upper left rear.

The heating cooker 100 further includes a discharge unit 40. As illustrated in FIGS. 2, 3, and 5, the discharge unit 40 partitions the second space R2 into an inside and an outside thereof. The discharge unit 40 is a plate-shaped member having a crank cross sectional shape. A lower portion of the discharge unit 40 is bent toward the front side. A dimension of the discharge unit 40 in the left-right direction is set to be substantially the same as a dimension of the lower wall 54 in the left-right direction. A front end of the discharge unit 40 is positioned behind a front end of the door 20. Specifically, the discharge unit 40 is disposed below the opening 61. An upper portion of the discharge unit 40 is fixed to a lower surface of the lower wall 54. As illustrated in FIG. 5, the discharge unit 40 has discharge ports 41.

The discharge port 41 allows an inside and an outside of the second space R2 to communicate with each other. The discharge port 41 is formed in, for example, a rectangular shape, and a plurality of discharge ports are provided. The plurality of discharge ports 41 are arranged in a row in the left-right direction.

As illustrated in FIGS. 5 to 7, the heating cooker 100 includes a microwave supply unit 110, a first heater unit 120, a second heater unit 130, and the air blower 140. Each of the microwave supply unit 110, the first heater unit 120, the second heater unit 130, and the air blower 140 heats the heating-target object.

First, the microwave supply unit 110 will be described. The microwave supply unit 110 supplies microwaves into the heating cooking compartment 50.

The microwave supply unit 110 is disposed on the upper wall 53 of the heating cooking compartment 50. Specifically, the microwave supply unit 110 is positioned above the heating cooking compartment 50 with the upper wall 53 interposed therebetween. The microwave supply unit 110 includes a partition member 111, a radiation chamber, a magnetron 113, and a waveguide 114.

The magnetron 113 is disposed closer to the front wall 60 than the first heater unit 120. The magnetron 113 generates microwaves. The waveguide 114 propagates microwaves generated by the magnetron 113 to the radiation chamber.

As illustrated in FIG. 3, the partition member 111 is disposed between the radiation chamber and the upper wall 53 of the heating cooking compartment 50. Examples of a material of the partition member 111 are non-metals, and include a ceramic or mica. As a result, since the material of the partition member 111 contains a ceramic or mica, the partition member 111 transmits microwaves. On the other hand, materials of the radiation chamber and the waveguide 114 include metals.

Next, the first heater unit 120 will be described. As illustrated in FIG. 5, the first heater unit 120 is disposed above the heating cooking compartment 50. Specifically, the first heater unit 120 is disposed on the upper wall 53 of the heating cooking compartment 50. The first heater unit 120 corresponds to, for example, a “heating unit”. As illustrated in FIG. 6, the first heater unit 120 includes a first heater 121, a thermal shield plate 122, a first tube 123, a heat reflection plate 124, and a glass plate 125.

The first heater 121 is, for example, a carbon heater. The first heater 121 in the state of power application generates heat. As a result, since the temperature rises quickly, the heating-target object can be cooked in a short time.

The thermal shield plate 122 shields heat. The thermal shield plate 122 covers an upper side, a front side, and a rear side of the heat reflection plate 124. The thermal shield plate 122 is made of a material including metal.

The first tube 123 is made of glass. The first tube 123 accommodates the first heater 121. The first tube 123 extends in the third direction D3.

The heat reflection plate 124 covers an upper side, a front side, and a rear side of the first heater 121. The heat reflection plate 124 reflects heat toward the heating cooking compartment 50. An air layer is provided between the heat reflection plate 124 and the thermal shield plate 122. The heat reflection plate 124 has a plurality of opening portions 124a. Air in the air layer passes through the opening portions 124a to exchange heat with the first heater 121.

The glass plate 125 is a substantially rectangular plate-shaped member. The glass plate 125 is disposed between a lower side of the first tube 123 and the heating cooking compartment 50. In other words, the glass plate 125 separates the first tube 123 from the heating cooking compartment 50. As a result, the glass plate 125 transmits heat rays from the first heater 121 to the heating cooking compartment 50. On the other hand, the glass plate 125 prevents moisture and salt from moving from the heating cooking compartment 50 to the first tube 123. Accordingly, a devitrification phenomenon of the first tube 123 can be prevented.

Next, the second heater unit 130 will be described. As illustrated in FIG. 5, the second heater unit 130 is disposed on the lower wall 54 of the heating cooking compartment 50. The second heater unit 130 includes a second heater 131 and a second heater case 132. The second heater 131 is, for example, a nichrome wire. The second heater 131 in the state of power application generates heat. An output of the second heater 131 is lower than an output of the first heater 121. The second heater case 132 covers a lower side, a front side, and a rear side of the second heater 131. The second heater case 132 is made of a material including metal. The second heater 131 in the state of power application generates heat.

Next, the air blower 140 will be described. The air blower 140 is configured to supply hot air into the heating cooking compartment 50. The air blower 140 is disposed in the third space R3. Specifically, the air blower 140 is positioned behind the heating cooking compartment 50 with the rear wall 55 interposed therebetween.

As illustrated in FIGS. 5 to 7, the air blower 140 includes an air blowing chamber 141, a third heater 142, a centrifugal fan 143, a drive unit 144, a partition member 145, and a heat shield plate 146. The air blowing chamber 141 is, for example, a box-shaped member made of metal. The centrifugal fan 143 has a plurality of blades.

The third heater 142 and the centrifugal fan 143 are accommodated in the air blowing chamber 141. The third heater 142 heats air inside the air blowing chamber 141 to generate hot air. Specifically, the third heater 142 has an annular shape when viewed from the front side toward the rear side. The third heater 142 is disposed along an outer circumference of the centrifugal fan 143.

As illustrated in FIG. 6, the rear wall 55 has a suction hole portion and a blow-out hole portion. To be specific, the suction hole portion is, for example, a group of a plurality of punched holes. Similarly, the blow-out hole portion is also, for example, a group of a plurality of punched holes. A punched hole has, for example, a circular shape. A diameter of a punched hole of each of the suction hole portion and the blow-out hole portion is, for example, 3 mm or larger and 4 mm or smaller in order to prevent microwaves from leaking from the inside of the heating cooking compartment 50. The diameter is preferably 3.4 mm.

The partition member 145 is, for example, a plate-shaped member made of metal. The partition member 145 has, for example, an oblong shape when viewed from the front side toward the rear side. The partition member 145 is disposed on substantially the entire surface of the rear wall 55. Specifically, the partition member 145 is positioned on the outward side from the rear wall 55.

The heat shield plate 146 is, for example, a plate-shaped member made of metal. The heat shield plate 146 is, for example, a plate-shaped member having a quadrangular ring shape when viewed from the front side toward the rear side. The heat shield plate 146 is positioned on the outward side from the partition member 145.

The drive unit 144 is positioned an outward side from the air blowing chamber 141. Specifically, the drive unit 144 is positioned on an outward side from the heat shield plate 146, and a shaft portion of the drive unit 144 penetrates the partition member 145 and the heat shield plate 146 and is connected to the centrifugal fan 143. The drive unit 144 drives the centrifugal fan 143. The drive unit 144 includes, for example, a motor.

The air blower 140 draws in hot air in the heating cooking compartment 50 through the suction hole portion, and blows hot air into the heating cooking compartment 50 through the blow-out hole portion. To be more specific, the air blower 140 draws in hot air from a central portion inside the heating cooking compartment 50 and blows the hot air to a peripheral border portion inside the heating cooking compartment 50. As a result, the entire inside of the heating cooking compartment 50 can be heated by driving the air blower 140.

As illustrated in FIGS. 2, 3, 5, and 7 again, the heating cooking compartment 50 further includes the intake hole portion 81, the exhaust hole portion 82, the intake damper unit 83, and the exhaust damper unit 84.

The intake hole portion 81 allows the inside and the outside of the heating cooking compartment 50 to communicate with each other. Specifically, the intake hole portion 81 is disposed on the left wall 52. The intake hole portion 81 has, for example, a quadrangular shape. Specifically, the intake hole portion 81 includes, for example, a plurality of punched holes. A punched hole has, for example, a circular shape. A diameter of a punched hole of the intake hole portion 81 is, for example, 3 mm or larger and 4 mm or smaller in order to prevent microwaves from leaking. The diameter is preferably 3.4 mm.

The intake damper unit 83 opens and closes the intake hole portion 81. The intake damper unit 83 is attached to an outer side of the left wall 52. For example, in a case where the intake damper unit 83 opens the intake hole portion 81, the inside and the outside of the heating cooking compartment 50 communicate with each other. As a result, air is guided to the intake hole portion 81. On the other hand, in a case where the intake damper unit 83 closes the intake hole portion 81, the inside and the outside of the heating cooking compartment 50 do not communicate with each other. As a result, air is not guided to the intake hole portion 81.

In addition, the exhaust hole portion 82 allows the inside and the outside of the heating cooking compartment 50 to communicate with each other. Specifically, the exhaust hole portion 82 is disposed on the right wall 51. The exhaust hole portion 82 has, for example, a quadrangular shape. Specifically, the exhaust hole portion 82 includes, for example, a plurality of punched holes. A punched hole has, for example, a circular shape. A diameter of a punched hole of the exhaust hole portion 82 is, for example, 3 mm or larger and 4 mm or smaller in order to prevent microwaves from leaking. The diameter is preferably 3.4 mm.

The exhaust damper unit 84 opens and closes the exhaust hole portion 82. The exhaust damper unit 84 is attached to an outer side of the right wall 51. For example, in a case where the exhaust damper unit 84 opens the exhaust hole portion 82, the inside and the outside of the heating cooking compartment 50 communicate with each other. On the other hand, in a case where the exhaust damper unit 84 closes the exhaust hole portion 82, the inside and the outside of the heating cooking compartment 50 do not communicate with each other.

A flow of air inside the heating cooking compartment 50 will be described. First, the intake damper unit 83 opens the intake hole portion 81, and the exhaust damper unit 84 opens the exhaust hole portion 82. As a result, air is guided to the intake hole portion 81. The air is blown into the heating cooking compartment 50 through the intake hole portion 81. The air blown from the intake hole portion 81 moves into the heating cooking compartment 50 in a direction opposite to the third direction D3. Thereafter, the air is discharged from the exhaust hole portion 82 to the outside of the heating cooking compartment 50. The air performs scavenging of steam or the like in the heating cooking compartment 50.

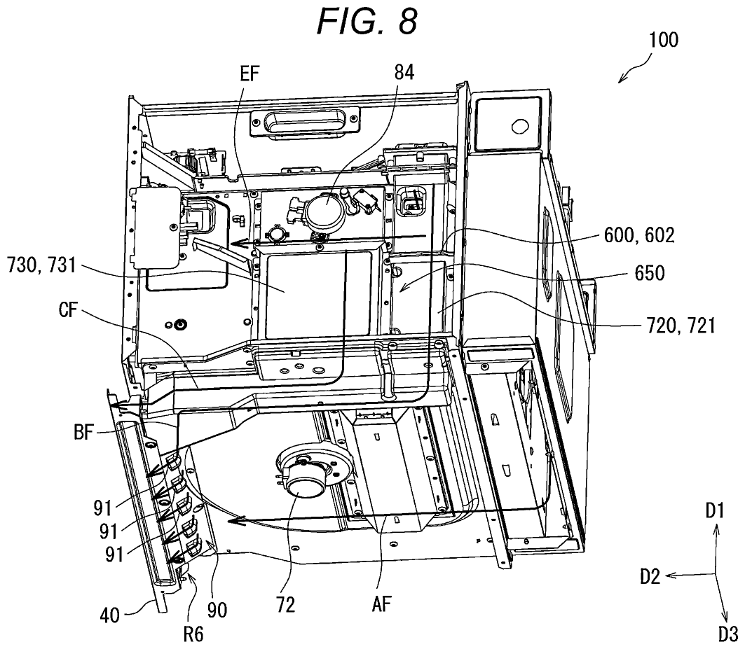

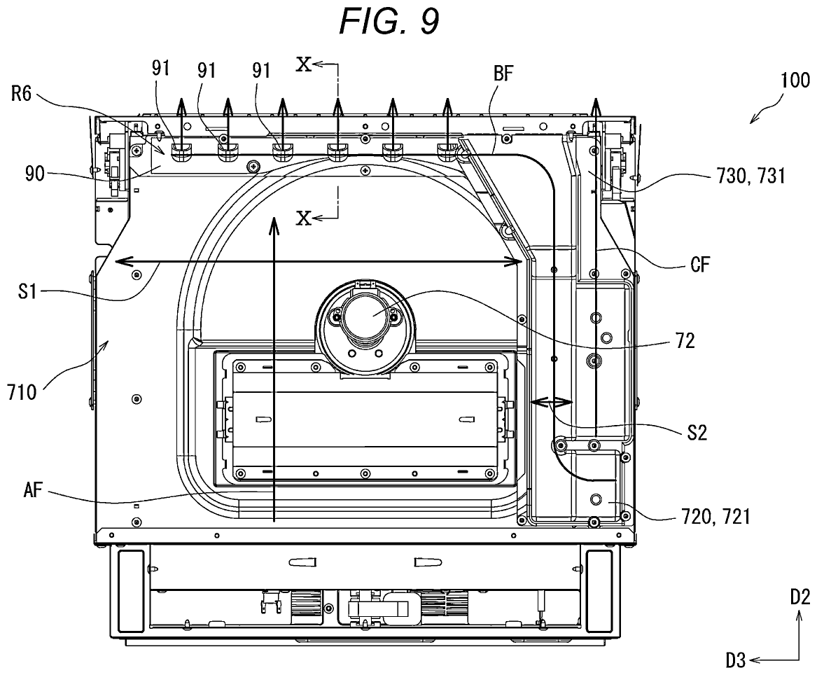

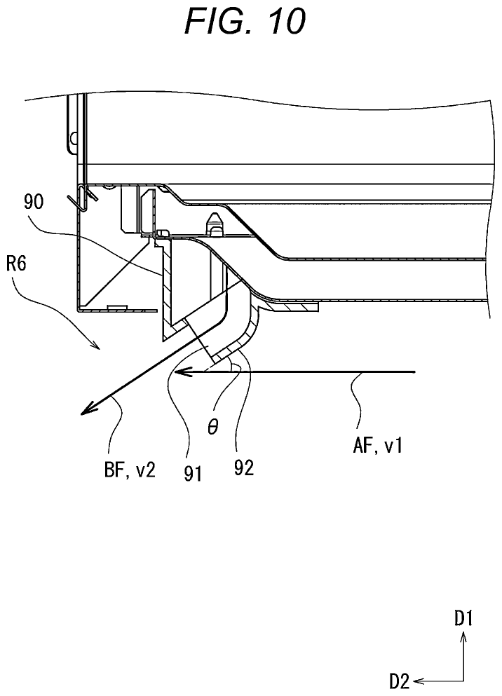

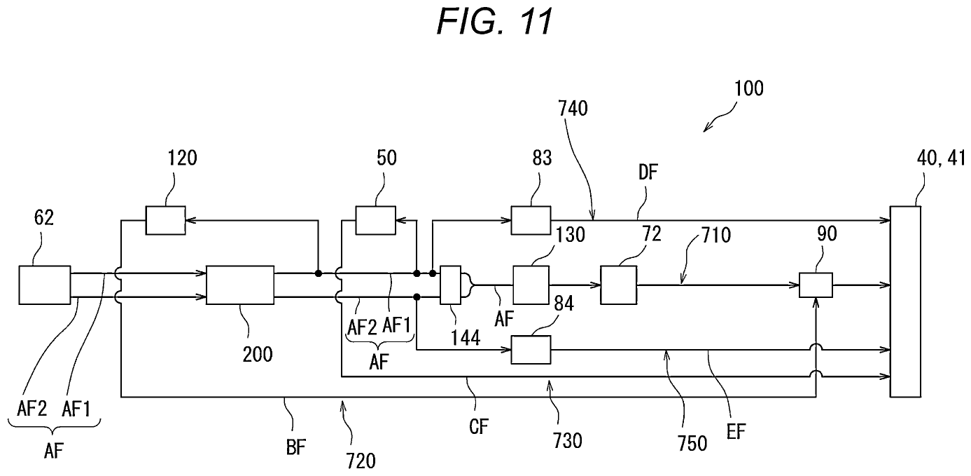

Next, the heating cooker 100 will be further described with reference to FIGS. 5 and 7 to 11. FIG. 8 is a perspective view illustrating the heating cooker 100 in a state where the housing 10 is removed according to the embodiment. To be specific, FIG. 8 illustrates the external appearance of the heating cooker 100 when viewed diagonally from the lower right rear. FIG. 9 is a bottom view illustrating the heating cooker 100 in a state where the housing 10 is removed according to the embodiment. FIG. 10 is a cross-sectional view along line X-X in FIG. 9. FIG. 11 is a view illustrating a flow of an air flow.

As illustrated in FIGS. 7 to 11, the heating cooker 100 includes a cooling fan 200, a first wind direction plate 500, a first guide unit 550, a second wind direction plate 600, a second guide unit 650, and a joining unit 90.

The cooling fan 200 generates an air flow. As illustrated in FIGS. 2, 5, 7 to 9, and 11, the cooling fan 200 generates a first air flow AF, a second air flow BF, a third air flow CF, a fourth air flow DF, and a fifth air flow EF. The second air flow BF, the third air flow CF, the fourth air flow DF, and the fifth air flow EF are branches from the first air flow AF.

The first air flow AF mainly cools the drive motor 72, the second heater unit 130, and the drive unit 144. The second air flow BF mainly cools the first heater unit 120. The third air flow CF mainly performs scavenging of the inside of the heating cooking compartment 50. The fourth air flow DF mainly cools a motor of the intake damper unit 83. The fifth air flow EF mainly cools a motor of the exhaust damper unit 84.

For example, the cooling fan 200 is a Sirocco fan. As illustrated in FIG. 7, the cooling fan 200 is disposed between the rear wall 55 of the heating cooking compartment 50 and the rear outer wall 15 of the housing 10. Specifically, the cooling fan 200 is disposed in a region in which the first space RI and the third space R3 overlap each other. The cooling fan 200 includes fans on both left and right sides of the drive unit, respectively. The cooling fan 200 includes a left fan portion 210 and a right fan portion 220.

The left fan portion 210 supplies cooling air to a left region of the cooling fan 200 to generate a left-side first air flow AF1 that is a part of the first air flow AF. The left fan portion 210 is positioned at the same height as the plurality of suction ports 62. The left fan portion 210 generates the left-side first air flow AF1 between the upper wall 53 of the heating cooking compartment 50 and the upper outer wall 13 of the housing 10. The left fan portion 210 takes air outside the heating cooker 100 into the first space R1. In addition, the left fan portion 210 generates the left-side first air flow AF1 between the rear wall 55 of the heating cooking compartment 50 and the rear outer wall 15 of the housing 10. The left fan portion 210 discharges the air in the first space R1 into the third space R3.

The right fan portion 220 is positioned at the same height as the plurality of suction ports 62. The right fan portion 220 generates a right-side first air flow AF2 between the upper wall 53 of the heating cooking compartment 50 and the upper outer wall 13 of the housing 10, the right-side first air flow AF2 being a part of the first air flow AF. The right fan portion 220 takes air outside the heating cooker 100 into the first space R1. In addition, the right fan portion 220 generates the right-side first air flow AF2 between the rear wall 55 of the heating cooking compartment 50 and the rear outer wall 15 of the housing 10. The right fan portion 220 discharges the air in the first space R1 into the third space R3. The left-side first air flow AF1 and the right-side first air flow AF2 are joined downstream of the cooling fan 200 (third space R3) to generate the first air flow AF.

As illustrated in FIG. 7, the first wind direction plate 500 includes a first skew plate 501, a second skew plate 503, and a horizontal plate 502.

The first skew plate 501 guides the third air flow CF into the first guide unit 550 toward the intake hole portion 81 via a vent 501a. The third air flow CF is a part of the left-side first air flow AF1. The first skew plate 501 guides the fourth air flow DF to the outside of the first guide unit 550 via a vent 501b. The fourth air flow DF is a part of the left-side first air flow AF1. Specifically, the first skew plate 501 is disposed on the heat shield plate 146. The first skew plate 501 is provided upright on the heat shield plate 146. The first skew plate 501 extends from below the left fan portion 210 toward the left wall 52.

The second skew plate 503 guides the second air flow BF into the first guide unit 550 toward the first heater unit 120 via a vent 503a. The second air flow BF flows in the thermal shield plate 122. The second air flow BF is a part of the left-side first air flow AF1. The second skew plate 503 guides the fourth air flow DF to the outside of the first guide unit 550 via the vent 501b. Specifically, the second skew plate 503 is disposed on the heat shield plate 146. The second skew plate 503 is provided upright on the heat shield plate 146. The second skew plate 503 is positioned on the upper side from the first skew plate 501. The second skew plate 503 extends from below the left fan portion 210 toward the left wall 52.

The horizontal plate 502 is disposed on the left wall 52. The horizontal plate 502 is provided upright on the left wall 52. The horizontal plate 502 passes below the intake damper unit 83 from the rear wall 55 and extends toward the front wall 60.

The first guide unit 550 guides the second air flow BF to the first heater unit 120. The first guide unit 550 guides the third air flow CF to the intake hole portion 81. Specifically, the first guide unit 550 is a cylindrical body. The cylindrical body has a suction port and a blow-out port. The cylindrical body is disposed on the left wall 52. The suction port is open in the direction opposite to the second direction D2. The blow-out port is open toward the first heater unit 120 and the intake hole portion 81.

As illustrated in FIGS. 2 and 7, the second wind direction plate 600 includes a skew plate 601 and a horizontal plate 602.

The skew plate 601 guides the fifth air flow EF to the exhaust damper unit 84. The fifth air flow EF is a part of the right-side first air flow AF2. The skew plate 601 is disposed on the heat shield plate 146. The skew plate 601 is provided upright on the heat shield plate 146. The skew plate 601 extends from below the right fan portion 220 toward the right wall 51.

The horizontal plate 602 is disposed on the right wall 51. The horizontal plate 602 is provided upright on the right wall 51. The horizontal plate 602 passes below the exhaust damper unit 84 from the rear wall 55 and extends toward the front wall 60.

As illustrated in FIG. 8, the second guide unit 650 guides the second air flow BF and the third air flow CF to the discharge unit 40. Specifically, the second guide unit 650 is a cylindrical body. The cylindrical body has a suction port and a blow-out port. The cylindrical body is disposed on the right wall 51. The suction port is open toward the first heater unit 120 and the exhaust hole portion 82. The blow-out port is open in the second direction D2.

As illustrated in FIG. 11, the heating cooker 100 includes a first flow channel section 710, a second flow channel section 720, a third flow channel section 730, a fourth flow channel section 740, and a fifth flow channel section 750.

The first flow channel section 710 allows the first air flow AF for cooling the drive motor 72, the second heater unit 130, and the drive unit 144 to flow inside. The first flow channel section 710 allows communication from the suction port 62 to the discharge port 41. Note that the first flow channel section 710 may allow the first air flow AF for cooling at least one of the drive motor 72 and the drive unit 144 to flow inside.

The second flow channel section 720 allows the second air flow BF for cooling the first heater unit 120 to flow inside. The second flow channel section 720 allows communication from a downstream position of the left fan portion 210 to the joining unit 90. Specifically, the second flow channel section 720 allows communication from the second skew plate 503 to the joining unit 90. In other words, the second flow channel section 720 allows the second air flow BF to circulate from the second skew plate 503 to the discharge port 41. That is, the second air flow BF that has cooled the first heater unit 120 and has a high temperature is guided to the joining unit 90 positioned in the vicinity of the discharge unit 40 through the second flow channel section 720 that is a dedicated path, and thereby it is possible to reduce some thermal effects on other components. The second flow channel section 720 corresponds to, for example, a “flow channel”.

The joining unit 90 causes the second air flow BF to be joined into the first air flow AF. As a result, discharge of the second air flow BF in a high temperature state to the outside of the housing 10 can be reduced. Specifically, since the joining unit 90 causes the second air flow BF that has cooled the first heater unit 120 having a heat release value larger than that of the drive motor 72 to be joined into the first air flow AF, the first air flow AF and the second air flow BF are mixed. That is, heat exchange between the first air flow AF and the second air flow BF is performed. That is, the discharge unit 40 discharges the first air flow AF and the second air flow BF subjected to the heat exchange to the outside of the housing 10. In particular, in a case where a carbon heater having high heating power is used, a temperature of the carbon heater itself becomes very high, and thus, there is a possibility that a temperature of a constituent member such as a lead wire or a glass tube will exceed a heat resistant temperature thereof. In order to secure reliability of the constituent member, the embodiment has a structure in which the carbon heater itself is directly cooled by cooling air. Therefore, the second air flow BF that has directly cooled the carbon heater itself has a high temperature. A dedicated flow channel (the second flow channel section 720) is provided so as not to affect other components as much as possible, and an air flow having an extremely high temperature is guided to the vicinity of the discharge port 41, mixed with another air flow (the first air flow AF) having a low temperature immediately in front of the discharge port 41, and discharged.

The first flow channel section 710 includes the upper outer wall 13 and the upper wall 53, the rear outer wall 15 and the heat shield plate 146, and the lower outer wall 14 and the lower wall 54. As illustrated in FIG. 9, when a flow channel area of the first flow channel section 710 is defined as a flow channel area S1 (cross-sectional area orthogonal to a main flow), and a flow channel area of the second flow channel section 720 is defined as a flow channel area S2, the flow channel area S1 of the first flow channel section 710 is larger than the flow channel area S2 of the second flow channel section 720. A flow quantity of the first air flow AF can be made larger than that of the second air flow BF. Hence, the temperature of the second air flow BF discharged to the outside of the housing 10 can be further lowered. In the embodiment, the flow channel area S1 is the smallest flow channel area of the first flow channel section 710, and the flow channel area S2 is the smallest flow channel area of the second flow channel section 720.

As illustrated in FIG. 10, a flow velocity v1 of the first air flow AF is preferably higher than a flow velocity v2 of the second air flow BF. The flow velocity v1 is set to be higher than the flow velocity v2, and thereby it is possible to reduce discharge of the second air flow BF in a higher temperature state to the outside from the discharge unit 40 without sufficient mix. In addition, since a sixth space R6 (a joining space R6) is in a lower pressure state as the flow velocity v1 increases, an effect of suctioning the second air flow BF from the plurality of blow-out ports 91 can be obtained. The flow velocity v1 and the flow velocity v2 are, for example, velocities immediately before the first air flow AF and the second air flow BF are joined.

As illustrated in FIGS. 8 and 9, the second flow channel section 720 has a second flow channel member 721 in a downstream region. The second flow channel member 721 is positioned between the right outer wall 11 and the right wall 51 and between the lower outer wall 14 and the lower wall 54. A downstream end of the second flow channel member 721 is connected to the joining unit 90. The second flow channel member 721 extends downward from a right-side position of the first heater unit 120. The second flow channel member 721 extends downward and is bent, and then extends frontward and is connected to a right end of the joining unit 90.

As illustrated in FIGS. 8 and 9, the joining unit 90 is disposed at a position in the vicinity of a rear side of the discharge unit 40, between the lower outer wall 14 and the lower wall 54. Specifically, the joining unit 90 is disposed on a front side from the drive motor 72. The joining unit 90 is formed in an elongated shape and extends in the third direction D3. The joining unit 90 is disposed to extend in a direction intersecting the traveling direction of the first air flow AF. As illustrated in FIG. 10, the joining unit 90 has blow-out ports 91 and guide portions 92.

The blow-out ports 91 allow the second air flow BF to be blown into the first air flow AF. For example, a plurality of blow-out ports 91 are provided. As illustrated in FIGS. 8 and 9, the plurality of blow-out ports 91 are arranged in a direction intersecting the traveling direction of the first air flow AF in a state of being separated at predetermined intervals. Since the joining unit 90 extends in the direction intersecting the traveling direction of the first air flow AF, the second air flow BF can be supplied from the plurality of blow-out ports 91 to the first air flow AF. Accordingly, since the second air flow BF is blown in a dispersed state, the first air flow AF and the second air flow BF are easily mixed. Specifically, the plurality of blow-out ports 91 are arranged in a direction substantially orthogonal to the traveling direction of the first air flow AF.

As illustrated in FIGS. 8 to 10, the blow-out ports 91 blow out the second air flow BF to the sixth space R6. The sixth space R6 is a front end portion of the second space R2.

Specifically, the sixth space R6 is a space defined by the lower outer wall 14, the lower wall 54, the discharge unit 40, and the joining unit 90. The second air flow BF is blown to the sixth space R6 via the joining unit 90.

As illustrated in FIG. 10, the guide portions 92 are arranged upstream of the blow-out port 91. An inclination direction of the guide portion 92 intersects the traveling direction of the first air flow AF. The inclination direction indicates a direction from an upstream side to a downstream side of the second air flow BF. A traveling direction of the second air flow BF blown from the blow-out ports 91 is a direction in which the second air flow BF is guided by the guide portions 92. Even in a case where the second air flow BF is supplied to the first air flow AF from a position separated from a main flow region of the first air flow AF, the traveling direction of the second air flow BF guided by the guide portions 92 intersects the traveling direction of the first air flow AF, so that the second air flow BF approaches the main flow region of the first air flow AF. Accordingly, the first air flow AF and the second air flow BF are further mixed. Note that a main flow region of an air flow means a region where the flow velocity is high. In the embodiment, the traveling direction of the second air flow BF intersects the traveling direction of the first air flow AF at an acute angle θ from above.

As illustrated in FIGS. 7 and 11, the cooling fan 200 is disposed inside the first flow channel section 710. The first flow channel section 710 branches to the second flow channel section 720 from a downstream position of the cooling fan 200. Since the first flow channel section 710 branches to the second flow channel section 720 from the downstream position of the cooling fan 200, the second air flow BF can travel in a pushing direction of the cooling fan 200. Hence, since the second air flow BF easily flows in a target direction, the cooling efficiency for the first heater unit 120 can be improved. Specifically, the second air flow BF is guided by the first skew plate 501 and the second skew plate 503.

As illustrated in FIGS. 7 and 11, the cooling fan 200 is disposed on an upper portion in the housing 10. The first heater unit 120 is disposed on the front side from the cooling fan 200. That is, the first heater unit 120 is disposed on the door 20 side from the cooling fan 200 is. In addition, the first heater unit 120 is disposed above the heating cooking compartment 50. The suction ports 62 are disposed on an upper front side of the heating cooker 100. The discharge port 41 (see FIG. 5) is disposed on a lower front side of the heating cooker 100. That is, since the suction port 62 and the discharge port 41 are separated from each other, it is possible to reduce an increase in ambient temperature in the vicinity of the suction ports 62. Hence, the cooling performance for the first heater unit 120 and the cooling performance for the drive motor 72 can be enhanced. In particular, in a built-in type heating cooker 100, it is necessary to dispose the suction ports 62 and the discharge ports 41 on the front side of the heating cooker 100 as in the embodiment.

The second flow channel section 720 is disposed to extend in a direction intersecting the traveling direction of the first air flow AF in a plan view. Consequently, a degree of freedom of layout of the first heater unit 120 can be increased. Specifically, since the second flow channel section 720 extends in the direction orthogonal to the traveling direction of the first air flow AF in a plan view, the first flow channel section 710 and the second flow channel section 720 can be arranged in an intersecting state. Hence, the second flow channel section 720 can be disposed regardless of a positional relationship between the first flow channel section 710 and the first heater unit 120.

Next, a flow of air inside the heating cooking compartment 50 will be described.

As illustrated in FIGS. 8 and 9, the third flow channel section 730 has a third flow channel member 731 in a downstream region. The third flow channel member 731 is positioned between the right outer wall 11 and the right wall 51 and between the lower outer wall 14 and the lower wall 54. A downstream end of the third flow channel member 731 faces the discharge unit 40. The third flow channel member 731 extends downward from a right-side position of the exhaust hole portion 82. The third flow channel member 731 extends downward and is bent frontward, and then extends frontward to a position facing the discharge unit 40.

The third flow channel section 730 allows the third air flow CF for scavenging the inside of the heating cooking compartment 50 to flow inside. The third flow channel section 730 allows communication from a downstream position of the left fan portion 210 to a downstream position of the first flow channel section 710. As illustrated in FIGS. 7, 9, and 11, specifically, the third flow channel section 730 allows communication from the first skew plate 501 to the inside of the heating cooking compartment 50 via the first guide unit 550, and allows communication from the inside of the heating cooking compartment 50 to a position in the vicinity of the discharge unit 40. The third air flow CF reaching the first skew plate 501 is guided to the left wall 52 along the second skew plate 503. The third air flow CF guided to the left wall 52 enters the inside of the heating cooking compartment 50 from the inside of the first guide unit 550 via the intake hole portion 81. The third air flow CF containing steam in the heating cooking compartment 50 travels toward the third flow channel member 731 via the exhaust hole portion 82. The third air flow CF is discharged to the outside of the heating cooker 100. The second guide unit 650 constitutes a part of the second flow channel section 720 and a part of the third flow channel section 730.

The fourth flow channel section 740 allows the fourth air flow DF that mainly cools the motor of the intake damper unit 83 to flow inside. The fourth flow channel section 740 allows communication from a downstream position of the left fan portion 210 to a downstream position of the first flow channel section 710. As illustrated in FIGS. 7 and 11, specifically, the fourth flow channel section 740 allows communication from the first skew plate 501 to a downstream position of the first flow channel section 710. The fourth air flow DF reaching the first skew plate 501 is guided to the left wall 52 along the first skew plate 501 and the second skew plate 503. The fourth air flow DF guided to the left wall 52 circulates in the second direction D2 along the horizontal plate 502 to cool the motor of the intake damper unit 83. The fourth air flow DF that has cooled the motor of the intake damper unit 83 is discharged to the outside of the heating cooker 100.

The fifth flow channel section 750 allows the fifth air flow EF that mainly cools the motor of the exhaust damper unit 84 to flow inside. The fifth flow channel section 750 allows communication from a downstream position of the right fan portion 220 to a downstream position of the first flow channel section 710. As illustrated in FIGS. 2 and 11, specifically, the fifth flow channel section 750 allows communication from the skew plate 601 to a downstream position of the first flow channel section 710. The fifth air flow EF reaching the skew plate 601 is guided to the right wall 51 along the skew plate 601. The fifth air flow EF guided to the right wall 51 circulates in the second direction D2 along the horizontal plate 602 to cool the motor of the exhaust damper unit 84. The fifth air flow EF that has cooled the motor of the exhaust damper unit 84 is discharged to the outside of the heating cooker 100.

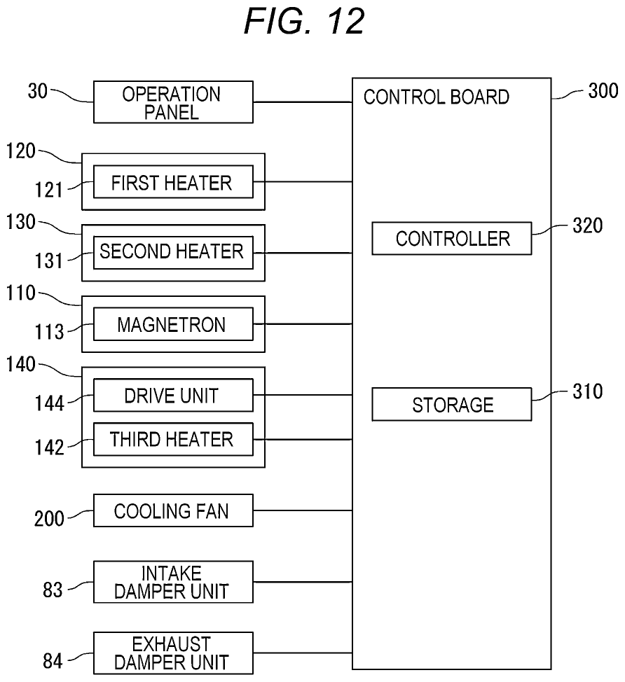

Next, the heating cooker 100 will be further described with reference to FIGS. 7 and 12. FIG. 12 is a block diagram illustrating a configuration of the heating cooker 100 according to the embodiment.

As illustrated in FIGS. 7 and 12, the heating cooker 100 further includes a control board 300, a high-voltage capacitor 330, and a high-voltage transformer 340.

The control board 300 includes a storage 310 and a controller 320. The storage 310 includes a random access memory (RAM) and a read only memory (ROM). The storage 310 stores control programs for controlling an operation of each component of the heating cooker 100.

The controller 320 is a hardware circuit including a processor such as a central processing unit (CPU). The controller 320 executes the control programs stored in the storage 310.

The high-voltage capacitor 330 is disposed between the left fan portion 210 and the right fan portion 220 and the suction ports 62.

The high-voltage transformer 340 is disposed between the right fan portion 220 and the suction ports 62.

As illustrated in FIG. 7 again, the heating cooker 100 further includes a front duct member 234 and a rear duct member 230.

With reference to FIG. 12, a configuration of the heating cooker 100 will be described in detail. In the embodiment, the heating cooker 100 has, as heating cooking modes, a “microwave heating mode”, a “hot air circulation heating mode”, and a “grill heating mode”.

The “microwave heating mode” is a mode for heating and cooking a heating-target object mainly by radiating microwaves into the heating cooking compartment 50. The “grill heating mode” means a mode for heating and cooking a heating-target object mainly by causing heat generated from the first heater unit 120 and the second heater unit 130 to radiate to the heating-target object. The “hot air circulation heating mode” is a mode for heating and cooking a heating-target object mainly by circulating hot air throughout the heating cooking compartment 50 to ensure a uniform temperature in the heating cooking compartment 50.

The controller 320 executes control programs stored in the storage 310, thereby controlling driving of the microwave supply unit 110, driving of the air blower 140, driving of the first heater unit 120, driving of the second heater unit 130, and driving of the cooling fan 200.

To be specific, the controller 320 controls the operation panel 30, the magnetron 113, the first heater 121, the second heater 131, the third heater 142, the drive unit 144, the cooling fan 200, the intake damper unit 83, and the exhaust damper unit 84. For example, in the case where the “microwave heating mode” is selected, the controller 320 drives the magnetron 113, the cooling fan 200, the intake damper unit 83, and the exhaust damper unit 84. In addition, in the case where the “grill heating mode” is selected, the controller 320 drives the first heater 121, the second heater 131, the cooling fan 200. Further, in the case where the “hot air circulation heating mode” is selected, the controller 320 drives the drive unit 144, the cooling fan 200, and drives at least one of the first heater 121, the second heater 131, and the third heater 142.

The embodiment of the present disclosure has been described above with reference to the drawings. However, the present disclosure is not limited to the above embodiment, and can be implemented in various aspects without departing from the gist thereof. For easy understanding, the drawings schematically illustrate the individual components mainly, and the thicknesses, lengths, number, and the like of the individual components illustrated in the drawings are different from actual ones for convenience of preparation of the drawings. In addition, the materials, shapes, dimensions, and the like of the individual components illustrated in the above embodiment are merely examples, and are not particularly limited, and various modifications can be made without substantially departing from the effects of the present disclosure.

(1) As described with reference to FIGS. 1 to 12, in the embodiment, the state where the smallest flow channel area S1 of the first flow channel section 710 is larger than the smallest flow channel area S2 of the second flow channel section 720 is provided, but the present disclosure is not limited thereto. An average flow channel area of the first flow channel section 710 may be defined as the flow channel area S1, and an average flow channel area of the second flow channel section 720 may be defined as the flow channel area S2.

(2) As described with reference to FIGS. 1 to 12, in the embodiment, the state where the second air flow BF intersects the traveling direction of the first air flow AF at the acute angle e from above and is joined into the first air flow AF is provided, but the present disclosure is not limited thereto. The traveling direction of the second air flow BF may intersect the traveling direction of the first air flow AF at an acute angle θ from below and is joined into the first air flow AF. In addition, the joining unit 90 may be disposed in the main flow region of the first air flow AF, and the second air flow BF may be directly supplied to the main flow region of the first air flow AF.

(3) As described with reference to FIGS. 1 to 12, in the embodiment, an example in which a first heat generating unit is the drive motor 72 and a second heat generating unit is the first heater unit 120 has been described, but the present disclosure is not limited thereto. At least the second heat generating unit may have a larger amount of heat generation than that of the first heat generating unit, and the first heat generating unit may be the drive unit 144, and the second heat generating unit may be the second heater unit 130, for example.

The present disclosure provides a heating cooker, and has industrial applicability.

What is claimed is:

1. A heating cooker comprising:
a heating cooking compartment configured to accommodate a heating-target object;
a housing configured to accommodate the heating cooking compartment, a heating unit configured to heat the heating-target object;
a fan configured to generate a first air flow circulating through a space other than the heating unit and a second air flow circulating through the heating unit; and
a flow channel configured to guide only the second air flow that has passed through the heating unit to a vicinity of a discharge unit communicating with an outside of the housing,
wherein the second air flow guided to the vicinity of the discharge unit through the flow channel and the first air flow are joined and discharged from the discharge unit.

2. The heating cooker according to claim 1, wherein
the flow channel includes a joining unit configured to cause the second air flow to join the first air flow,
the joining unit is disposed to extend in a direction intersecting a traveling direction of the first air flow,
the joining unit has a plurality of blow-out ports, and
the plurality of blow-out ports are arranged in a direction intersecting the traveling direction of the first air flow in a state of being separated at predetermined intervals.

3. The heating cooker according to claim 2, wherein
each of the blow-out ports includes a guide portion disposed upstream,
an inclination direction of the guide portion intersects the traveling direction of the first air flow, and
the inclination direction indicates a direction from an upstream side to a downstream side of the second air flow.

4. The heating cooker according to claim 1, wherein
the heating unit includes a carbon heater, a heat reflection plate, and a thermal shield plate,
the heat reflection plate has an opening portion, and
at least a part of the second air flow directly cools the carbon heater through the opening portion.
